(19) United States
(12) Patent Application Publication
(10) Pub. No.: US 2018/0366039 A1
(43) Pub. Date: Dec. 20, 2018

(54) WIRELESSLY READABLE BOLT SEAL ASSEMBLY

(71) Applicant: HI-G-TEK, INC., Rockville, MD (US)

(72) Inventors: Micha AUERBACH, Modi'in (IL); Rony COHEN, Zoran (IL); Reuven ILYAEV, Tel Aviv (IL)

(73) Assignee: HI-G-TEK, INC., Rockville, MD (US)

(21) Appl. No.: 16/060,100

(22) PCT Filed: Dec. 8, 2016
(86) PCT No.: PCT/IL2016/051314

§ 371 Date: Jun. 7, 2018

Related U.S. Application Data
(60) Provisional application No. 62/264,408, filed on Dec. 8, 2015.

(51) Int. Cl. G09F 3/03; G08B 13/06

(52) U.S. Cl. CPC G09F 3/0335; G09F 3/0317; G08B 13/06

(57) ABSTRACT

A wirelessly readable bolt seal assembly including a seal portion including an wireless communication module located within a housing, a pin portion including a shaft, the pin portion being fixedly connected to the wireless communication module and a cap portion arranged for selectable and non-removable mechanical and wirelessly readable locking engagement with the pin portion, the seal portion and the cap portion being cooperative to provide a wirelessly readable locking indication to a remote receiver upon non-removable locking engagement of the seal portion and the cap portion and thereafter.

### REFERENCE TO RELATED APPLICATIONS

Reference is hereby made to U.S. Provisional Patent Application Ser. No. 62/264,408, filed Dec. 8, 2015 and entitled DISPOSABLE ELECTRONIC BOLT SEAL (DEBS), the disclosure of which is hereby incorporated by reference and priority of which is hereby claimed pursuant to 37 C.F.R. 1.78(a)(1).

### FIELD OF THE INVENTION

The present invention relates to bolt seals conventionally used for sealing shipping containers and more particularly to electronic bolt seals.

### BACKGROUND OF THE INVENTION

Various types of bolt seals are known. International Standard ISO-17712 sets forth standards for bolt seals used for maritime containers in commerce with the United States. U.S. Pat. No. 8,319,647 and U.S. Published Patent Application No. 2011/0273852A1 describe examples of electronically readable bolt seals.

### SUMMARY OF THE INVENTION

The present invention seeks to provide improved electronically readable bolt seals.

There is thus provided in accordance with a preferred embodiment of the present invention a wirelessly readable bolt seal assembly including a seal portion including a wireless communication module located within a housing, a pin portion including a shaft, the pin portion being fixedly connected to the wireless communication module and a cap portion arranged for selectable and non-removable mechanical and wirelessly readable locking engagement with the pin portion, the seal portion and the cap portion being cooperative to provide a wirelessly readable locking indication to a remote receiver upon non-removable locking engagement of the seal portion and the cap portion and thereafter.

In accordance with a preferred embodiment of the present invention the seal portion and the cap portion are programmed to communicate with and identify each other.

Preferably, the wirelessly readable bolt seal assembly also includes an actuation pull tab. Additionally, the wireless communication module includes electronic circuitry which is actuated by pulling the pull tab.

In accordance with a preferred embodiment of the present invention the wireless communication module includes active RF communications circuitry. Alternatively, the cap portion includes a first LED and light sensor, the seal portion includes a second LED and light sensor and the first LED and light sensor and the second LED and light sensor are programmed to communicate with and identify each other.

In accordance with a preferred embodiment of the present invention the wirelessly readable bolt seal assembly also includes an antenna operative to communicate with a remote host. Additionally, the antenna is operative to communicate with the remote host at predetermined intervals of time. Additionally or alternatively, at least one of the antenna and the remote host is operative to provide an alarm indication in the event of tampering with the wirelessly readable bolt seal assembly.

Preferably, the shaft includes first and second circumferential locking grooves. Additionally, the cap portion also includes a spring operative, when the cap portion is not locked in the second circumferential locking groove, to push the cap portion and the shaft in opposite directions until stopped by engagement of the cap portion with the first circumferential locking groove.

In accordance with a preferred embodiment of the present invention the shaft includes a visual indicator providing a visual indication of full insertion of the shaft into the cap portion. Additionally, the visual indicator is visible only when the shaft and the cap portion are not fully engaged.

There is also provided in accordance with another preferred embodiment of the present invention a wirelessly readable bolt seal assembly including a seal portion including a wireless communication module located within a housing, a pin portion including a shaft, the pin portion being fixedly connected to the wireless communication module and a cap portion arranged for selectable and non-removable mechanical and wirelessly readable locking engagement with the pin portion, the seal portion and the cap portion being cooperative to provide an RF locking indication to a remote receiver upon non-removable locking engagement of the seal portion and the cap portion and thereafter.

### BRIEF DESCRIPTION OF THE DRAWINGS

The present invention will be understood and appreciated more fully from the following detailed description, taken in conjunction with the drawings in which:

FIGS. 1 and 2 are simplified illustrations of a wirelessly readable bolt seal assembly constructed and operative in accordance with a preferred embodiment of the present invention in respective unlocked and locked operative orientations;

FIG. 3 is a simplified exploded view illustration of the wirelessly readable bolt seal assembly of FIGS. 1 and 2 in accordance with one embodiment of the present invention;

FIG. 4 is a simplified illustration of part of the seal portion of the wirelessly readable bolt seal assembly of FIGS. 1-3; and

FIG. 5 is a simplified illustration of a cap portion of the wirelessly readable bolt seal assembly of FIGS. 1 and 2 in accordance with an alternative embodiment of the present invention.

### DETAILED DESCRIPTION OF PREFERRED EMBODIMENTS

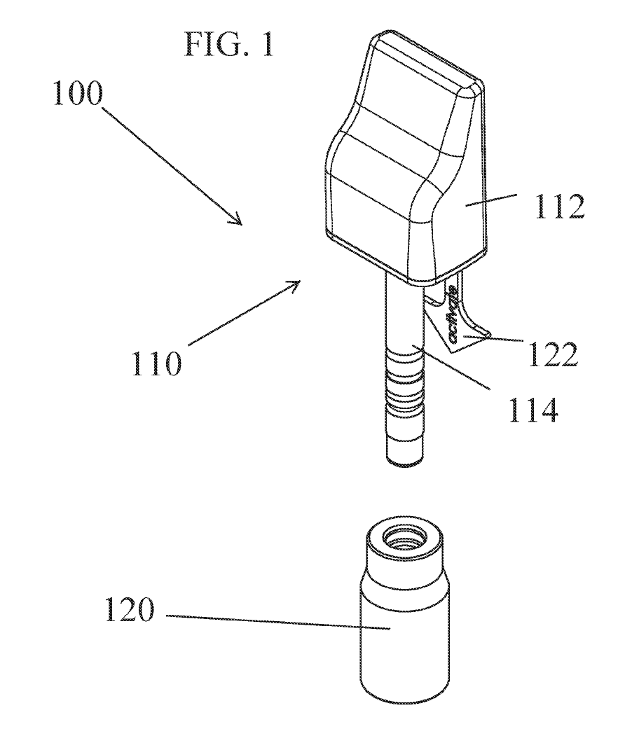

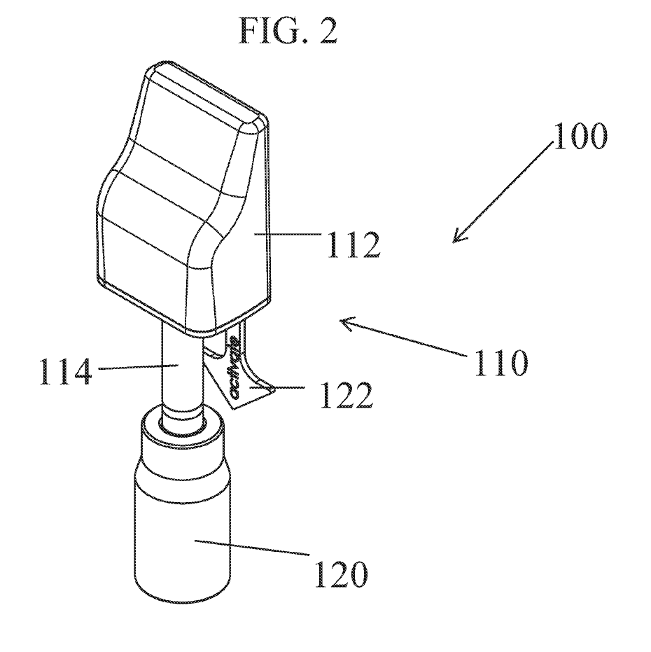

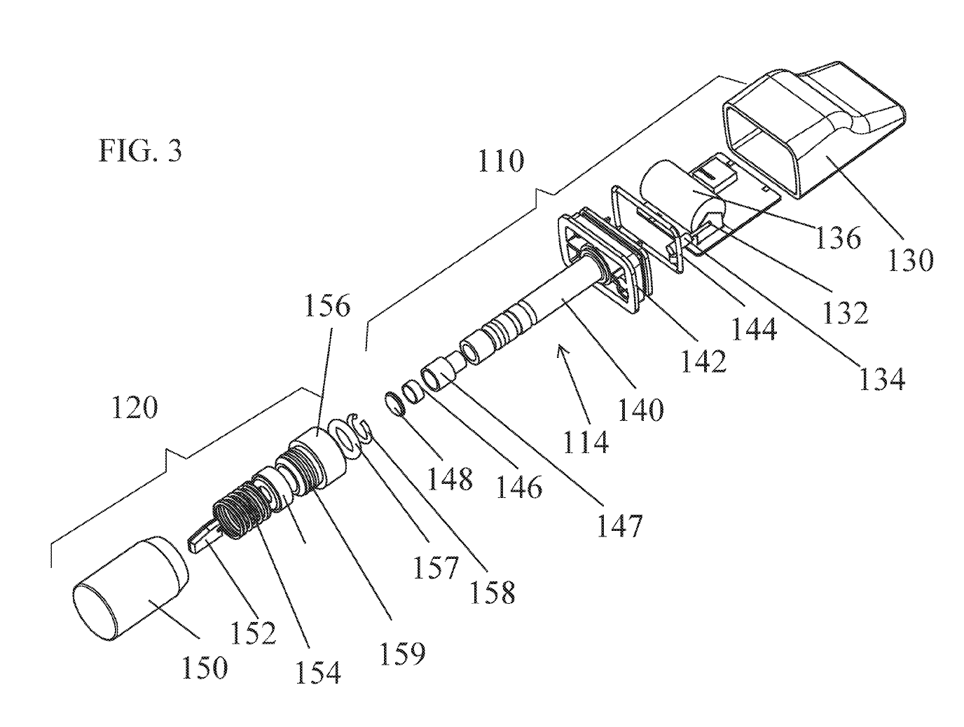

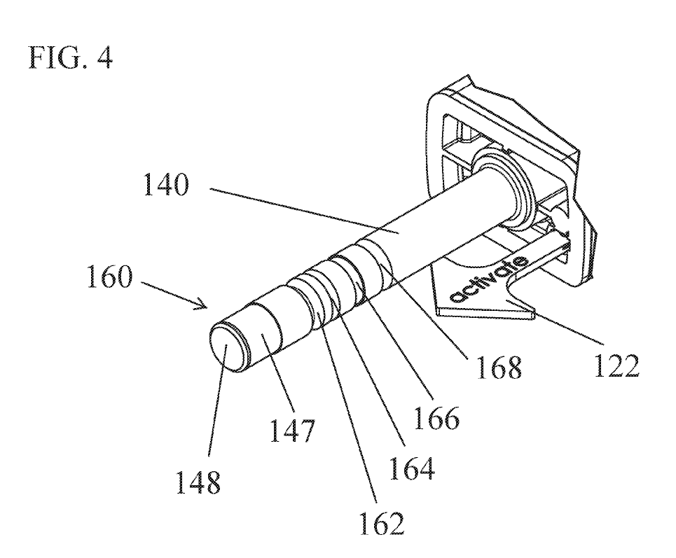

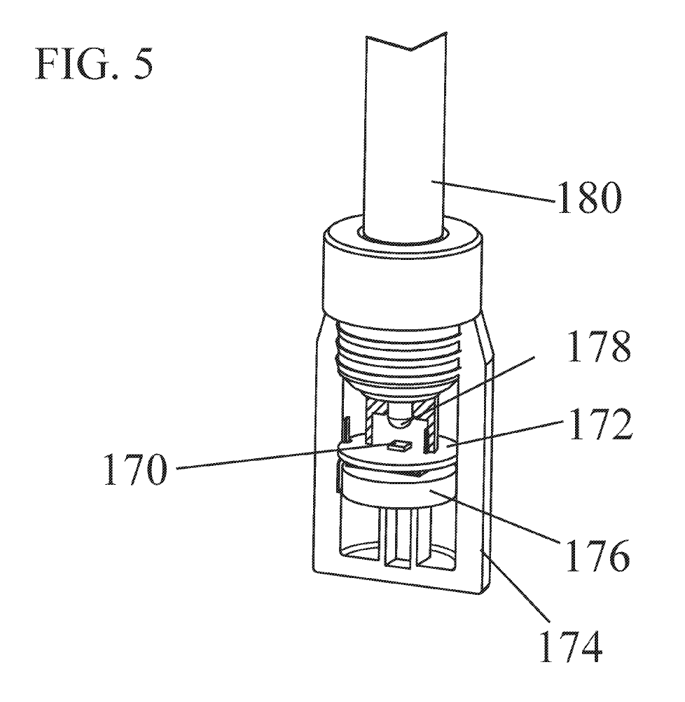

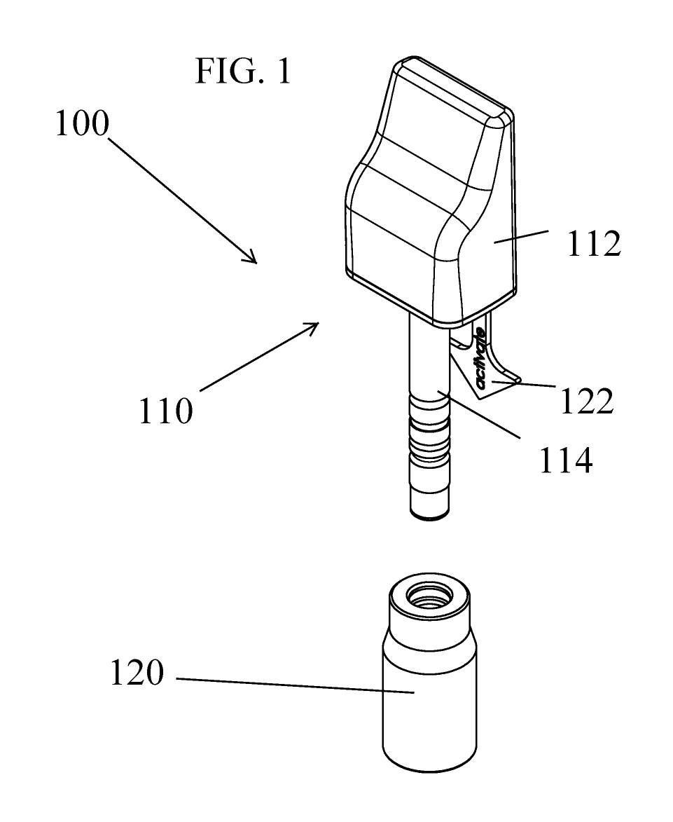

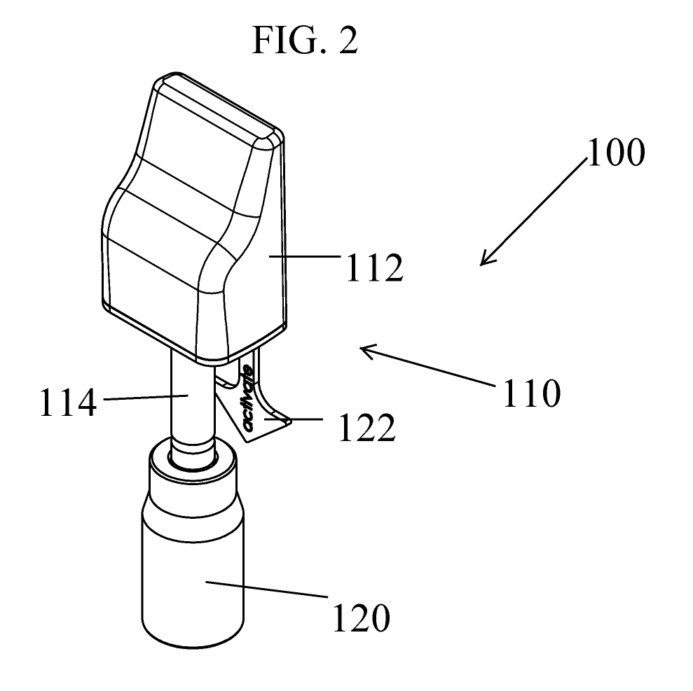

Reference is now made to FIGS. 1 and 2, which are simplified illustrations of a wirelessly readable bolt seal assembly constructed and operative in accordance with a preferred embodiment of the present invention in respective unlocked and locked operative orientations.

As seen in FIGS. 1 & 2, the wirelessly readable bolt seal assembly, here designated by reference numeral 100, comprises a seal portion 110, including a body portion 112 which is fixedly attached to a pin portion 114, and a cap portion 120 into which the pin portion 114 is lockably receiveable. The seal portion 110 may be provided with an optional actuation pull tab 122, which is operative, when pulled, to actuate electronic circuitry in the body portion 112, which otherwise may be in a deep sleep mode for power conservation.

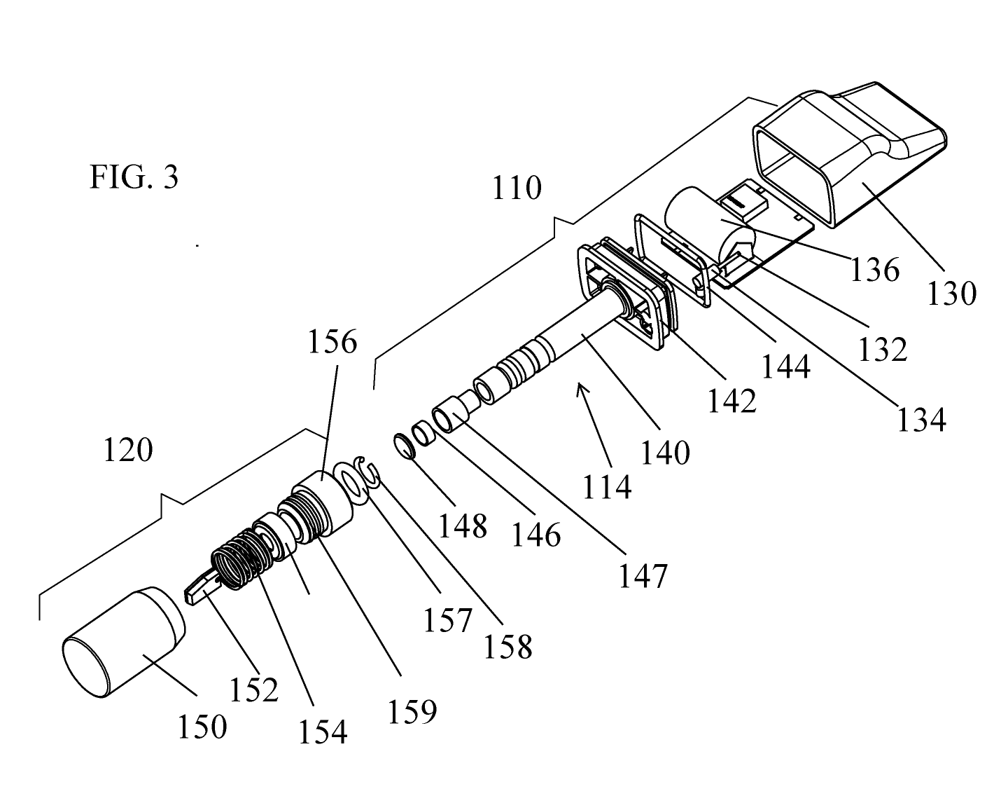

Reference is now made to FIG. 3, which is a simplified exploded view illustration of the wirelessly readable bolt seal assembly of FIGS. 1 and 2 in accordance with one embodiment of the present invention.

As seen in FIG. 3, the seal portion 110 includes a body portion housing 130, which partially encloses a wireless communication module 132. Wireless communication module 132 preferably includes RF communications circuitry which is operative to report to a remote host, such as via an antenna forming part of wireless communication module 132, the locking status of the wirelessly readable bolt seal assembly 100, specifically, whether the assembly is locked and whether it has been tampered with or the pin portion 114 has been cut. It is important that this reporting take place not only upon locking but thereafter following locking. Such reporting may be at predetermined intervals of time or when interrogated, such as by remote RF communication signals. Wireless communication module 132 may also include a sensor 134 for sensing actuation of actuation pull tab 122. Wireless communication module 132 also preferably includes a battery 136 located therein which provides electrical power to the wirelessly readable bolt seal assembly 100.

It is appreciated that one or more RF communication channels may be provided, and may include either or both of short range RF communication and long range RF communication.

It is appreciated that in addition to reporting the status of the wirelessly readable bolt seal assembly 100, wireless communication module 132 may also provide an alarm indication in the event of tampering with the wirelessly readable bolt seal assembly 100. Additionally or alternatively, the remote host may provide an alarm indication upon receipt of communication from the wireless communication module 132 regarding the locking status of the wirelessly readable bolt seal assembly 100.

As also seen in FIG. 3, the pin portion 114 includes a shaft 140, which is securely mounted onto a base 142, which together with housing 130 fully encloses the wireless communication module 132 and protects it from tampering. An O-ring 144 preferably provides a hermetic seal for the interior of the body portion housing 130, to protect the wireless communication module 132.

As further seen in FIG. 3, an RF antenna 146 is preferably fixed at the end of shaft 140 via an antenna housing portion 147 and an antenna cap 148.

As additionally seen in FIG. 3, the cap portion 120 preferably includes a cap housing 150 which encloses an RFID tag 152, a spring 154, a spring seat 155, a sealing portion 156, an O-ring 157 for environmental sealing and a locking ring 158 for locking shaft 140 thereto once shaft 140 is inserted therein. It is appreciated that sealing portion 156 includes a toothed portion 159 which sealingly engages cap portion 150.

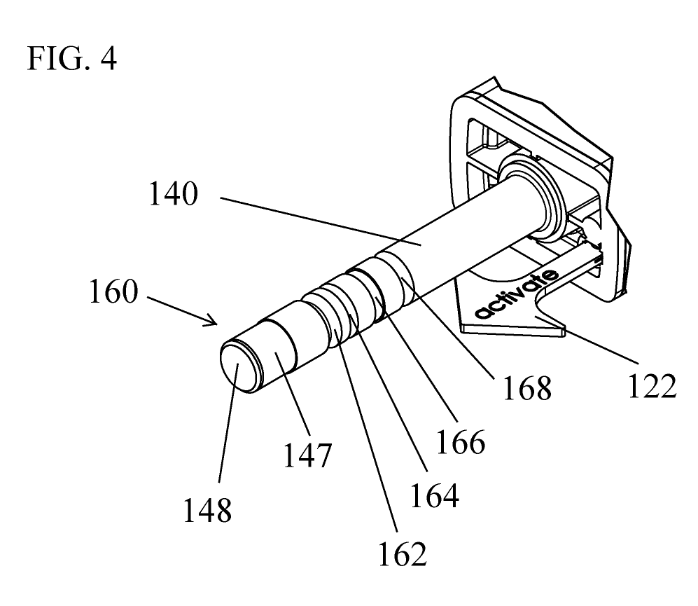

Reference is now made to FIG. 4, which is a simplified illustration of part of the seal portion of the wirelessly readable bolt seal assembly of FIGS. 1-3 and shows details of shaft 140. It is appreciated that RF antenna 146 is enclosed in antenna housing portion 147 and antenna cap 148, which are mounted onto shaft 140 and provide an RFID reading head 160. The shaft 140 includes first and second circumferential locking grooves 162 and 164 and a visual indicating stripe 166 for indicating full insertion of the shaft 140 in cap portion 120. Optionally, a weakened circumferential groove 168 is provided for use in authorized removal of the bolt seal assembly 100, by cutting the shaft. It is appreciated that when shaft 140 is fully inserted into cap portion 120, visual indicating stripe 166 is no longer visible and thus provides a visual indication of full engagement of shaft 140 and cap portion 120.

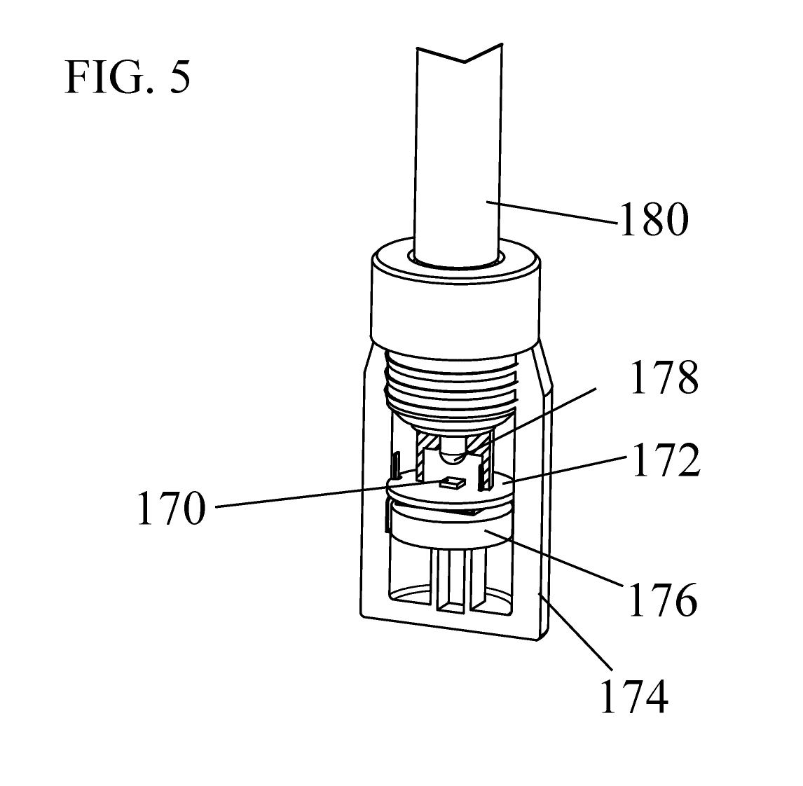

Reference is now made to FIG. 5, which shows an alternative embodiment of the present invention, in which RFID functionality is replaced by provision of a first LED and light sensor 170 on a PCB 172 fixed within a cap portion 174, together with a battery 176, and a second LED and light sensor 178 mounted onto a shaft 180 forming part of the seal pin.

The functionality of the wirelessly readable bolt seal assembly 100 of FIGS. 3 and 4 described above is summarized below:

When the shaft 140 is inserted into the cap portion 120, the locking ring 158 is caught in first circumferential locking groove 162. Preferably, locking ring 158 provides a first indication, such as a click, of engagement of first circumferential locking groove 162 of shaft 140 therewith. At this point, the shaft 140 is mechanically locked and cannot be removed from the cap portion 120, however the RFID tag 152 is not yet read by the RFID reading head 160 and a locked indication is not provided or communicated. Further engagement of the cap portion 120 and the shaft 140, as by pushing the cap portion 120 further onto the shaft 140 causes the locking ring 158 to engage the second circumferential locking groove 164. Preferably, locking ring 158 provides a second indication, such as a click, of engagement of second circumferential locking groove 164 of shaft 140 therewith. In this operative orientation, the RFID tag 152 is read by the RFID reading head 160 and a locked indication is provided and communicated by the wireless communication module 132. If the cap portion 120 is not locked in the second circumferential locking groove 164, the spring 166 pushes the cap portion 120 away from shaft 140 until stopped by engagement of the locking ring 158 and the first circumferential locking groove 162.

It is appreciated that the wireless communication module 132 of seal portion 110 is preferably programmed during manufacture thereof to communicate with and identify a specific RFID tag 152 of a specific cap portion 120 and that an attempt to utilize a different cap portion or a different seal portion, which may provide a mechanical locking engagement, will not result in a locking engagement that is recognized by the wireless communication module 132.

Similarly, it is appreciated that in the embodiment illustrated in FIG. 5, first LED and light sensor 170 is preferably programmed during manufacture thereof to communicate with and identify a specific second LED and light sensor 178 of a specific cap portion 174 and that an attempt to utilize a different cap portion or a different seal portion, which may provide a mechanical locking engagement, will not result in a locking engagement that is recognized by the wireless communication module 132.

It will be appreciated by persons skilled in the art that the present invention is not limited by what has been particularly shown and described hereinabove. Rather the scope of the present invention includes both combinations and subcombinations of features described and illustrated as well as modifications and variations thereof which are not in the prior art.

1. A wirelessly readable bolt seal assembly comprising:
a seal portion comprising:
a wireless communication module located within a housing;
a pin portion including a shaft, said pin portion being fixedly connected to said wireless communication module; and
a cap portion arranged for selectable and non-removable mechanical and wirelessly readable locking engagement with said pin portion,
said seal portion and said cap portion being cooperative to provide a wirelessly readable locking indication to a remote receiver upon non-removable locking engagement of said seal portion and said cap portion and thereafter.

2. A wirelessly readable bolt seal assembly according to claim 1 and wherein said seal portion and said cap portion are programmed to communicate with and identify each other.

3. A wirelessly readable bolt seal assembly according to claim 1 and also including an actuation pull tab.

4. A wirelessly readable bolt seal assembly according to claim 3 and wherein said wireless communication module includes electronic circuitry which is actuated by pulling said pull tab.

5. A wirelessly readable bolt seal assembly according to claim 1 and wherein said wireless communication module includes active RF communications circuitry.

6. A wirelessly readable bolt seal assembly according to claim 1 and wherein:
said cap portion includes a first LED and light sensor;
said seal portion includes a second LED and light sensor; and
said first LED and light sensor and said second LED and light sensor are programmed to communicate with and identify each other.

7. A wirelessly readable bolt seal assembly according to claim 1 and also comprising an antenna operative to communicate with a remote host.

8. A wirelessly readable bolt seal assembly according to claim 7 and wherein said antenna is operative to communicate with said remote host at predetermined intervals of time.

9. A wirelessly readable bolt seal assembly according to claim 7 and wherein at least one of said antenna and said remote host is operative to provide an alarm indication in the event of tampering with the wirelessly readable bolt seal assembly.

10. A wirelessly readable bolt seal assembly according to claim 1 and wherein said shaft includes first and second circumferential locking grooves.

11. A wirelessly readable bolt seal assembly according to claim 10 and wherein said cap portion also includes a spring operative, when said cap portion is not locked in said second circumferential locking groove, to push said cap portion and said shaft in opposite directions until stopped by engagement of said cap portion with said first circumferential locking groove.

12. A wirelessly readable bolt seal assembly according to claim 1 and wherein said shaft includes a visual indicator providing a visual indication of full insertion of said shaft into said cap portion.

13. A wirelessly readable bolt seal assembly according to claim 12 and wherein said visual indicator is visible only when said shaft and said cap portion are not fully engaged.

14. A wirelessly readable bolt seal assembly comprising:
a seal portion comprising:
a wireless communication module located within a housing;
a pin portion including a shaft, said pin portion being fixedly connected to said wireless communication module; and
a cap portion arranged for selectable and non-removable mechanical and wirelessly readable locking engagement with said pin portion,
said seal portion and said cap portion being cooperative to provide an RF locking indication to a remote receiver upon non-removable locking engagement of said seal portion and said cap portion and thereafter.

15. A wirelessly readable bolt seal assembly according to claim 2 and also including an actuation pull tab.

16. A wirelessly readable bolt seal assembly according to claim 2 and wherein said wireless communication module includes active RF communications circuitry.

17. A wirelessly readable bolt seal assembly according to claim 2 and wherein:
said cap portion includes a first LED and light sensor;
said seal portion includes a second LED and light sensor; and
said first LED and light sensor and said second LED and light sensor are programmed to communicate with and identify each other.

18. A wirelessly readable bolt seal assembly according to claim 2 and also comprising an antenna operative to communicate with a remote host.

19. A wirelessly readable bolt seal assembly according to claim 2 and wherein said shaft includes first and second circumferential locking grooves.

20. A wirelessly readable bolt seal assembly according to claim 2 and wherein said shaft includes a visual indicator providing a visual indication of full insertion of said shaft into said cap portion.
